(19) United States
(12) Patent Application Publication
(10) Pub. No.: US 2025/0210286 A1
(43) Pub. Date: Jun. 26, 2025

(54) SWITCH AND INSERT MOLDING METHOD

(71) Applicant: ALPS ALPINE CO., LTD., Tokyo (JP)

(72) Inventor: Akizumi SAITO, Tokyo (JP)

(21) Appl. No.: 19/077,781

(22) Filed: Mar. 12, 2025

Related U.S. Application Data
(63) Continuation of application No. PCT/JP2023/008705, filed on Mar. 8, 2023.

(30) Foreign Application Priority Data
Sep. 20, 2022 (JP) 2022-149124

(51) Int. Cl. H01H 13/10; H01H 1/06; H01H 13/14

(52) U.S. Cl. CPC H01H 13/10; H01H 13/14; H01H 1/06; H01H 2229/048

(57) ABSTRACT

A switch includes: a housing; a first fixed-contact member having a longitudinal shape; a second fixed-contact member; and a movable contact member. The housing includes a casing. The first fixed-contact member includes: a first external-connection terminal exposed from one end in a longitudinal direction of the housing; and a central fixed contact exposed from a central portion of a bottom of the casing. The first fixed-contact member extends from the first external-connection terminal to the central fixed contact in the longitudinal direction. The second fixed-contact member includes: a second external-connection terminal exposed from the other end in the longitudinal direction of the housing; and a plurality of peripheral fixed contacts exposed from a peripheral portion of the bottom of the casing. The second fixed-contact member extends from the second external-connection terminal to the plurality of peripheral fixed contacts in the longitudinal direction.

### CROSS-REFERENCE TO RELATED APPLICATIONS

This application is a continuation application of International Application No. PCT/JP2023/008705, filed on Mar. 8, 2023, and designated the U.S., which is based upon and claims priority to Japanese Patent Application No. 2022-149124, filed on Sep. 20, 2022, the entire contents of which are incorporated herein by reference.

### BACKGROUND

### 1. Field of the Invention

The present disclosure relates to a switch and an insert molding method.

### 2. Description of the Related Art

Japanese Laid-Open Patent Application No. 2019-061747 discloses a switch device provided with a resin housing integrally formed with a fixed contact member including a fixed contact by insert molding.

### SUMMARY

A switch according to one embodiment is provided with a housing having a longitudinal shape; a first fixed-contact member; a second fixed-contact member; and a movable contact member. The housing includes a casing. The first fixed-contact member includes: a first external-connection terminal configured to be exposed from one end in a longitudinal direction of the housing; and a central fixed contact configured to be exposed from a central portion of a bottom of the casing, and the first fixed-contact member is configured to extend from the first external-connection terminal to the central fixed contact in the longitudinal direction. The second fixed-contact member includes: a second external-connection terminal configured to be exposed from the other end in the longitudinal direction of the housing; and a plurality of peripheral fixed contacts configured to be exposed from a peripheral portion of the bottom of the casing, and the second fixed-contact member is configured to extend from the second external-connection terminal to the plurality of peripheral fixed contacts in the longitudinal direction. The movable contact member is capable of being brought into contact with and detached from the central fixed contact by inversion incurred by pressing. The first fixed-contact member includes extended supports projecting from sides of the central fixed contact in a transverse direction of the housing. Back surfaces of the extended supports are configured to serve as receivers for receiving resin ejected from gates upon insert molding of the housing.

### BRIEF DESCRIPTION OF THE DRAWINGS

FIG. 1 is an external perspective view of a switch according to one embodiment;

FIG. 2 is an exploded perspective view of the switch according to the embodiment;

FIG. 3 is a cross-sectional perspective view of the switch according to the embodiment, in a plane YZ;

FIG. 4 is an external perspective view of a housing provided in the switch according to the embodiment; FIG. 5 is an external perspective view of a central fixed-contact member and a peripheral fixed-contact member provided in the switch according to the embodiment;

FIG. 6 is a plan view of the housing provided in the switch according to the embodiment;

FIG. 7 is a plan view of the central fixed-contact member and the peripheral fixed-contact member provided in a switch according to the embodiment;

FIG. 8 is a bottom view of the housing provided in the switch according to the embodiment; and

FIG. 9 is a perspective sectional view of the housing provided in the switch according to the embodiment.

### DETAILED DESCRIPTION OF THE DISCLOSURE

With an existing switch device, especially when a contact area of the fixed contact is small, there is a possibility that the fixed contact cannot be firmly fixed to the housing generated by insert molding.

One embodiment will be described below with reference to the drawings. In the following description, for the sake of convenience, a Z-axis direction in the figures will be a vertical direction, a Y-axis direction in the figures will be a lateral direction, and an X-axis direction in the figures will be a front-rear direction. Additionally, a Z-axis positive direction will be an upward direction, a Y-axis positive direction will be a rightward direction, and an X-axis positive direction will be a forward direction.

### Overview of Switch 100

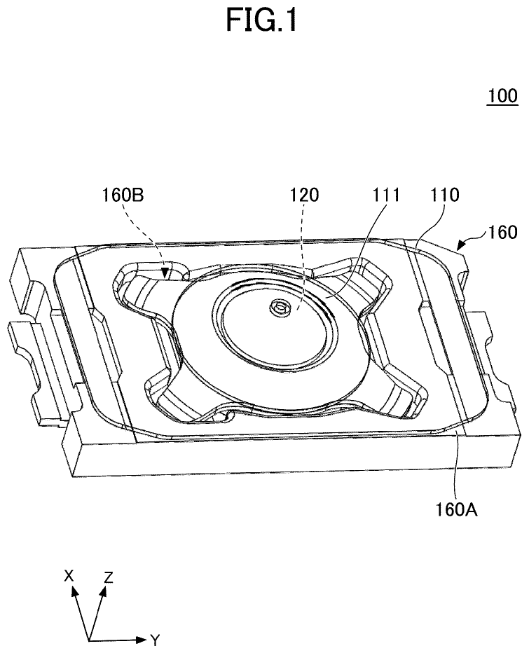

FIG. 1 is an external perspective view of a switch 100 according to one embodiment. As illustrated in FIG. 1, the switch 100 generally has a rectangular parallelepiped shape that is thin in the vertical direction (Z-axis direction). As illustrated in FIG. 1, an upper surface 160A of a housing 160 and a casing 160B of the switch 100 are covered with a transparent insulator 110. A protrusion 111 protruding upward (the Z-axis positive direction) is formed in the center of the insulator 110. A presser 120 is bonded to a back side (a Z-axis negative side) of the protrusion 111.

Thus, the switch 100 can be pressed downward (Z-axis negative direction) by the presser 120.

The switch 100 is in an OFF state when the presser 120 is not pressed. The switch 100 is switched to an ON state when the presser 120 is pressed downward (the Z-axis negative direction).

### Configuration of Switch 100

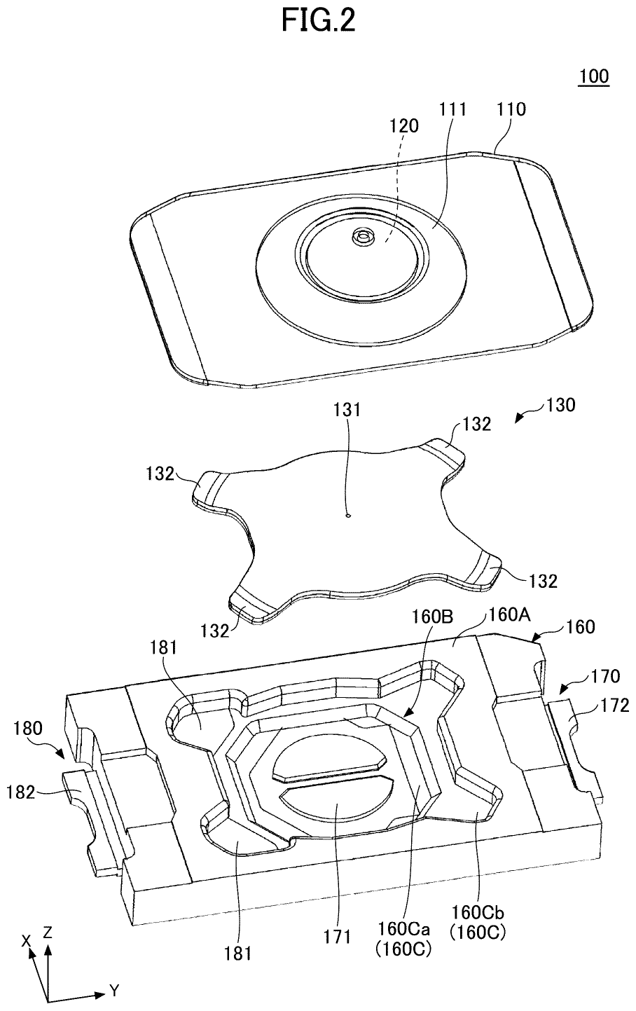

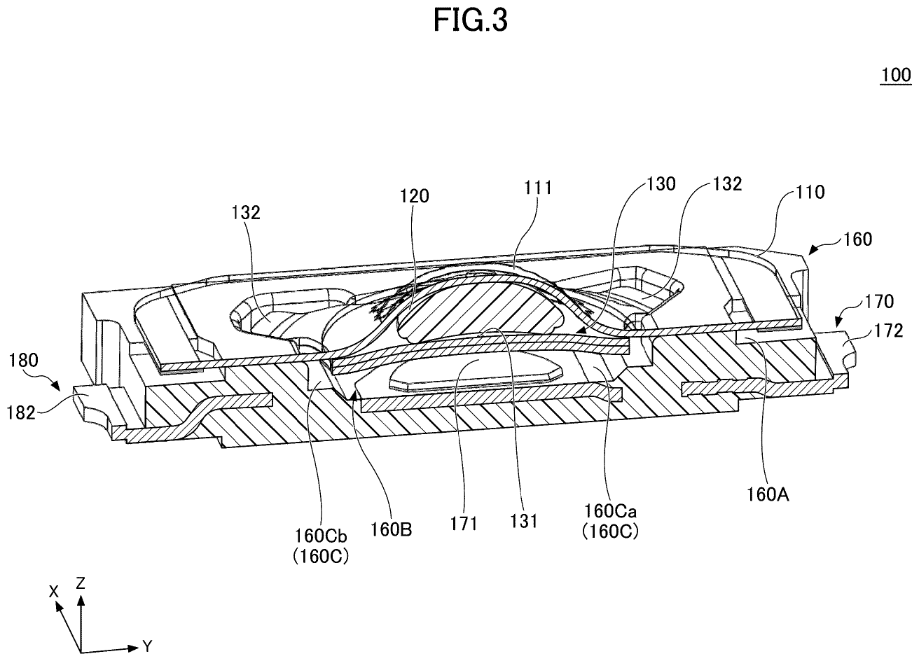

FIG. 2 is an exploded perspective view of the switch 100 according to the embodiment. FIG. 3 is a cross-sectional perspective view of the switch 100 according to the embodiment, in the YZ plane. As illustrated in FIGS. 2 and 3, the switch 100 includes, in order from a lower side (the Z-axis negative side) of the drawing, the housing 160, a metal contact 130, the presser 120, and the insulator 110.

### Housing 160

The housing 160 is a container-type member having a thin rectangular parallelepiped shape in the vertical direction (Z-axis direction). The housing 160 has a longitudinal shape in which the lateral direction (Y-axis direction) is a longitudinal direction and the front-rear direction (X-axis direction) is the transverse direction when viewed from above. The housing 160 includes the casing 160B which is recessed downward from the upper surface 160A. The metal contact 130 is cased in the casing 160B. For example, the housing 160 is formed integrally with a central fixed-contact member 170 and a peripheral fixed-contact member 180 by insert molding by using a relatively hard insulating material (for example, hard resins).

A bottom portion 160C of the casing 160B of the housing 160 includes a central portion 160Ca and a peripheral portion 160Cb.

The central portion 160Ca is formed in the center of the bottom portion 160C. The central portion 160Ca is provided with a central fixed contact 171 provided by the central fixed-contact member 170.

The peripheral portion 160Cb is formed outside the central portion 160Ca to surround the central portion 160Ca. The position of the peripheral portion 160Cb is higher than that of the central portion 160Ca. The peripheral portion 160Cb is provided with peripheral fixed contacts 181 provided by the peripheral fixed-contact member 180. The metal contact 130 is placed on the peripheral portion 160Cb.

The central fixed-contact member 170 and the peripheral fixed-contact member 180 are made of metal and are generally flat plate members. The central fixed-contact member 170 and the peripheral fixed-contact member 180 are integrally provided in the housing 160 by insert molding. For example, the central fixed-contact member 170 and the peripheral fixed-contact member 180 are formed by processing a metal plate by various processing methods (for example, press processing, bending processing, laser processing, etc.).

The central fixed-contact member 170 is an example of a “first fixed contact member”. The central fixed-contact member 170 includes a central fixed contact 171 at its left (Y-axis negative side) end and a first external-connection terminal 172 at its right (Y-axis positive side) end. The central fixed contact 171 is disposed at the central portion 160Ca of the bottom portion 160C of the housing 160. The first external-connection terminal 172 is exposed from a right-side (Y-axis positive side) surface of the housing 160 and is connected to the outside. Other portions of the central fixed-contact member 170 (excluding the central fixed contact 171 and the first external-connection terminal 172) are embedded in the housing 160.

The peripheral fixed-contact member 180 is an example of a “second fixed-contact member”. The peripheral fixed-contact member 180 includes a pair of peripheral fixed contacts 181 in a front-rear direction (the X-axis direction) at the right (the Y-axis positive side) end and a second external-connection terminal 182 at the left (the Y-axis negative side) end. The pair of peripheral fixed contacts 181 are arranged on the peripheral portion 160Cb of the bottom portion 160C of the housing 160. The second external-connection terminal 182 is provided being exposed from a left-side (the Y-axis negative side) surface of the housing 160 and is connected to the outside. Other portions of the peripheral fixed-contact member 180 (except the peripheral fixed contacts 181 and the second external-connection terminal 182) are embedded in the housing 160.

### Metal Contact 130

The metal contact 130 is an example of a “movable contact member”. The metal contact 130 is a dome-shaped member including a top portion 131 at the center and protruding upward (in the Z-axis positive direction). The metal contact 130 is formed by using one or more thin metal plates. In the present embodiment, as an example, the metal contact 130 is formed by stacking two thin metal plates. The metal contact 130 is cased in the casing 160B of the housing 160 and placed on the peripheral portion 160Cb of the bottom portion 160C of the casing 160B. Thus, the metal contact 130 is electrically connected to the peripheral fixed-contact member 180 by contacting the peripheral fixed contacts 181 provided on the peripheral portion 160Cb. The metal contact 130 is a so-called “invertible spring”, and when pressing is performed by the presser 120, the top portion 131 is pressed downward by the presser 120, and when a predetermined operation load is exceeded, the top portion 131 rapidly and elastically deforms to be a recessed shape (becomes inverted). Thus, the metal contact 130 is electrically connected to the central fixed-contact member 170 by contacting the central fixed contact 171 with a back side of the top portion 131. When the metal contact 130 is released from a pressing force of the presser 120, it returns to have an original dome shape by its elastic force. In the present embodiment, the metal

contact 130 includes four legs 132 projecting in four directions different from each other in a plan view from above by cutting a part of a circular dome-shaped metal plate in a plan view from above. In the present embodiment, all of the four legs 132 of the metal contact 130 are placed on the peripheral portion 160Cb of the housing 160, and two of the legs 132 contact the peripheral fixed contacts 181.

### Presser 120

The presser 120 is a member disposed on the top portion 131 of the metal contact 130 and in a space on the back side of the protrusion 111 of the insulator 110. The presser 120 has a circular shape in a plan view from above and a three-dimensional shape projecting upward from the top portion 131 of the metal contact 130. The presser 120 is formed by using a resin material such as PET. The presser 120 includes a curved upper surface along the protrusion 111 of the insulator 110, and the upper surface is bonded to the back side of the protrusion 111 of the insulator 110 by any adhesive means (for example, laser welding, etc.). In the present embodiment, the presser 120 has a three-dimensional shape such that a hemispherical shape is crushed in the vertical direction (Z-axis direction). However, the present embodiment is not limited to this, and the presser 120 may have a cylindrical shape, an ellipsoid shape, or the like. The presser 120 is not limited to a circular shape in a plan view from above.

### Insulator 110

The insulator 110 is a thin sheet member arranged on the upper surface 160A of the housing 160. The insulator 110 is formed of a resin material such as PET. The insulator 110 has substantially the same shape as the upper surface 160A of the housing 160 in a plan view from above, that is, a substantially rectangular shape in which the lateral direction (Y-axis direction) is the longitudinal direction and the front-rear direction (X-axis direction) is the transverse direction. The insulator 110 is bonded to the upper surface 160A of the housing 160 by any adhesive means (for example, laser welding, etc.) while covering the upper surface 160A of the housing 160. The insulator 110 seals the casing 160B by closing an upper opening of the casing 160B of the housing 160. The protrusion 111 protruding upward (Z-axis positive direction) is formed in the center of the insulator 110. As illustrated in FIG. 3, the presser 120 is bonded to the back side of the protrusion 111.

### Operation of Switch 100

In the switch 100 according to the embodiment, when no pressing is performed by the presser 120, the metal contact 130 is in contact with the peripheral fixed contacts 181 and not with the central fixed contact 171. Therefore, when no pressing is performed by the presser 120, the switch 100 according to the embodiment is in the OFF state.

In the switch 100 according to the embodiment, when pressing is performed by the presser 120, the presser 120 pushes down the top portion 131 of the metal contact 130 and elastically deforms (inverts) the top portion 131 of the metal contact 130 into a recessed shape. As a result, the back side of the top portion 131 of the metal contact 130 is electrically connected to the central fixed-contact member 170 by contacting the central fixed contact 171. As a result, the switch 100 is switched to the ON state by making the central fixed-contact member 170 and the central fixed contact 171, as well as the peripheral fixed-contact member 180 and the peripheral fixed contacts 181 conductive with each other through the central fixed-contact member 170.

In the switch 100 according to the embodiment, when pressing by the presser 120 is released, the metal contact 130 returns to its original recessed shape by its own elastic force. As a result, the contact of the metal contact 130 with the central fixed contact 171 is released, and the switch 100 returns to the OFF state.

### Configurations of Central Fixed-Contact Member 170 and Peripheral Fixed-Contact Member 180

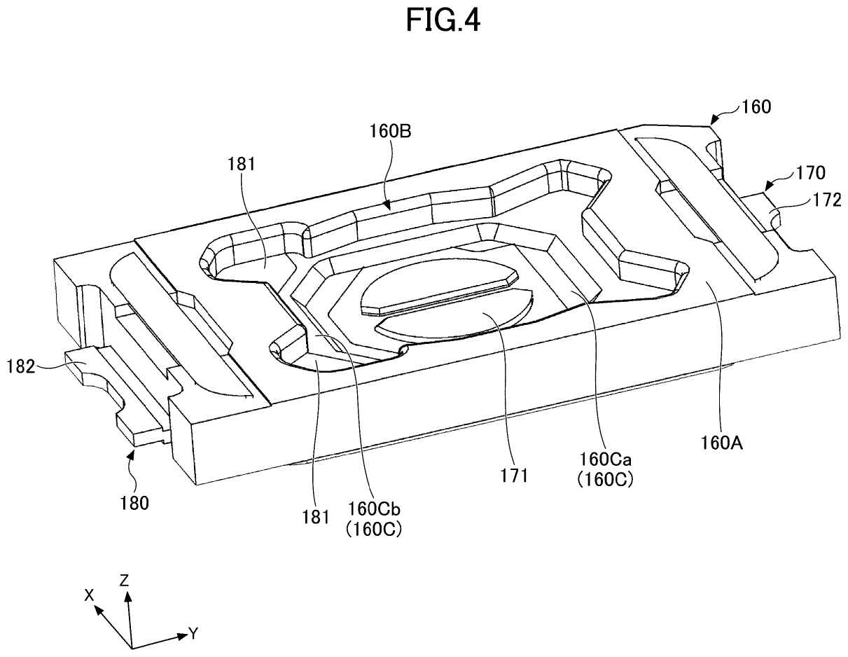

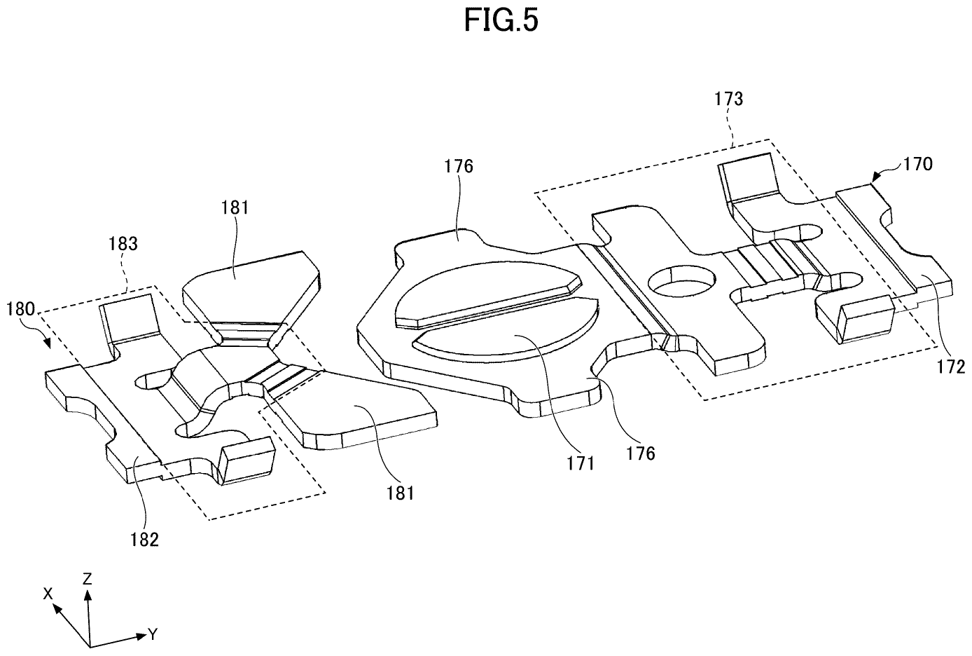

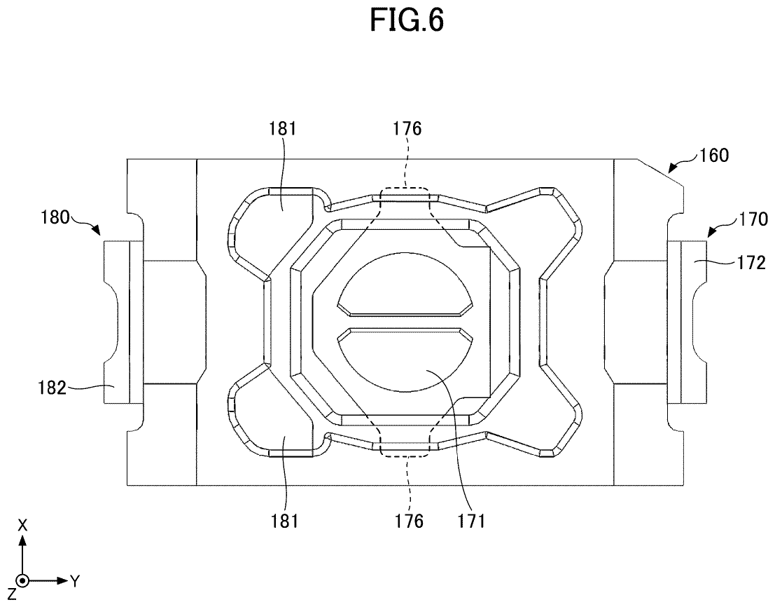

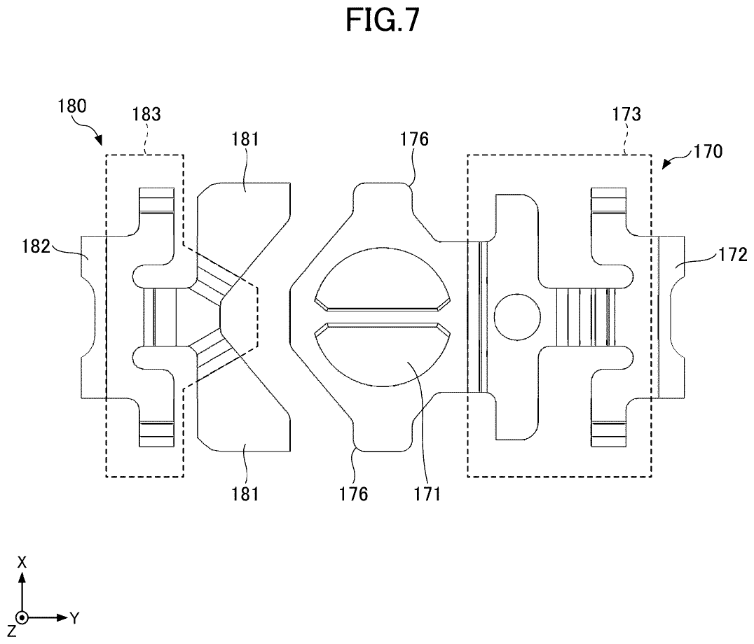

FIG. 4 is an external perspective view of the housing 160 provided in the switch 100 according to the embodiment. FIG. 5 is an external perspective view of the central fixed-contact member 170 and the peripheral fixed-contact member 180 provided in the switch 100 according to the embodiment. FIG. 6 is a plan view of the housing 160 provided in the switch 100 according to the embodiment. FIG. 7 is a plan view of the central fixed-contact member 170 and the peripheral fixed-contact member 180 provided in the switch 100 according to the embodiment.

As illustrated in FIGS. 4 to 7, the central fixed-contact member 170 includes the central fixed contact 171 at its left (Y-axis negative side) end and the first external-connection terminal 172 at its right (Y-axis positive side) end. The central fixed contact 171 is arranged in the central portion 160Ca of the bottom portion 160C of the housing 160. The first external-connection terminal 172 is exposed from the right-side (Y-axis positive side) surface of the housing 160.

As illustrated in FIGS. 5 and 7, the central fixed-contact member 170 includes an embedded portion 173 embedded in the housing 160, between the central fixed contact 171 and the first external-connection terminal 172. The embedded portion 173 extends in the lateral direction (Y-axis direction) as an extension direction and in the front-rear direction (X-axis direction) as a width direction.

As illustrated in FIGS. 4 to 7, the peripheral fixed-contact member 180 includes a pair of peripheral fixed contacts 181 at its right (Y-axis positive side) end and the second external-connection terminal 182 at the left (Y-axis negative side) end. The pair of peripheral fixed contacts 181 are arranged in the peripheral portion 160Cb of the bottom portion 160C of the housing 160. The second external-connection terminal 182 is provided to be exposed from the left-side (Y-axis negative side) surface of the housing 160.

As illustrated in FIGS. 5 and 7, the peripheral fixed-contact member 180 includes an embedded portion 183 embedded in the housing 160, between the pair of peripheral fixed contacts 181 and the second external-connection terminal 182. The embedded portion 183 is extended in the lateral direction (Y-axis direction) as the extension direction and in the front-rear direction (X-axis direction) as the width direction.

As illustrated in FIGS. 5 to 7, the central fixed-contact member 170 includes extended supports 176 projecting from sides of the central fixed contact 171 in the transverse direction (X-axis direction) of the housing 160. The extended supports 176 are integrally formed with the central fixed contact 171, that is, have a horizontal flat-plate shape. Each of the extended supports 176 has a substantially rectangular shape in a plan view from above (Z-axis positive direction).

As a result, the switch 100 according to the embodiment can partially expand the contact area of the central fixed contact 171 with respect to the housing 160 in the transverse direction (X-axis direction) of the housing 160, such that the central fixed contact 171 can be firmly fixed to the housing 160.

As illustrated in FIGS. 5 to 7, the extended supports 176 are provided as a pair linearly symmetrical with respect to a Y-axis with the central fixed contact 171 being interposed between the pair. Specifically, the pair of extended supports 176 are provided to be linearly symmetrical with respect to the Y-axis, that is, one of the pair on a front side (X-axis positive side) of the central fixed contact 171 and the other of the pair on a rear side (X-axis negative side) of the central fixed contact 171.

As a result, the switch 100 according to the embodiment can partially extend the contact area of the central fixed contact 171 with respect to the housing 160, in both directions of the transverse direction (X-axis direction) of the housing 160 and in a linearly symmetrical manner with respect to the Y-axis. Accordingly, the central fixed contact 171 can be fixed to the housing 160 more reliably and with a good balance in the transverse direction (X-axis direction).

As illustrated in FIG. 6, the extended supports 176 are embedded in the housing 160. As a result, the switch 100 according to the embodiment can more firmly fix the central fixed contact 171 with respect to the housing 160.

As illustrated in FIGS. 5 and 7, in the switch 100 according to the embodiment, a chevron-shaped portion of the central fixed contact 171 of the central fixed-contact member 170 and a valley-shaped portion formed by the pair of the peripheral fixed contacts 181 of the peripheral fixed-contact member 180, are arranged to face each other.

In this way, in the switch 100 according to the embodiment, the central fixed contact 171 can be arranged close to the pair of peripheral fixed contacts 181 while engaging the chevron-shaped portion of the central fixed contact 171 with the valley-shaped portion formed by the pair of the peripheral fixed contacts 181, and thus, the size of the housing 160 in the longitudinal direction can be reduced.

The insert molding method of the housing 160 provided in the switch 100 according to the embodiment includes an arrangement step in which the central fixed-contact member 170 and the peripheral fixed-contact member 180 are arranged in a mold including a gate under each of the extended supports 176 (positions facing back surfaces of the extended supports 176), and a resin ejection step in which resin is ejected from the gates arranged under the extended supports 176 toward the back surfaces of the extended supports 176 to fill the mold with resin.

Therefore, the back surfaces of the extended supports 176 serve as receivers for receiving resin ejected from the gates when the housing 160 is insert-molded.

Thus, when the housing 160 is insert-molded, the switch 100 according to the embodiment can prevent the pressure incurred by the resin ejected from the gates from being applied to the central portion of the central fixed contact 171, such that deformation of the central fixed contact 171 can be suppressed.

Moreover, in the switch 100 according to the embodiment, when insert-molding the housing 160, displacement of the central fixed-contact member 170 due to flow of the resin can be suppressed, by receiving the resin ejected from the gates by the extended supports 176 without using a pin for pressing the central fixed contact 171 against the mold. Therefore, since the switch 100 according to the embodiment can prevent pin traces from being formed on the housing 160, entry of flux into the housing 160 can be suppressed.

### Structure of Bottom Surface 160D of Housing 160

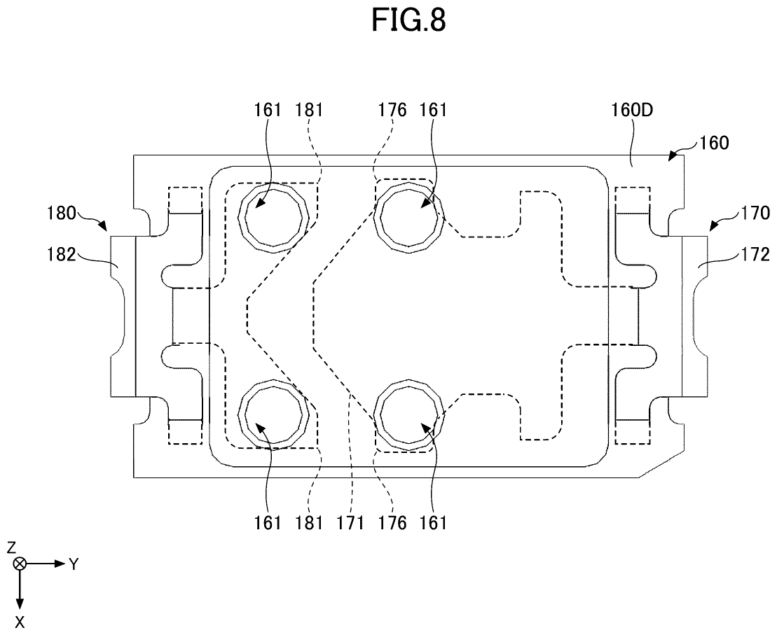

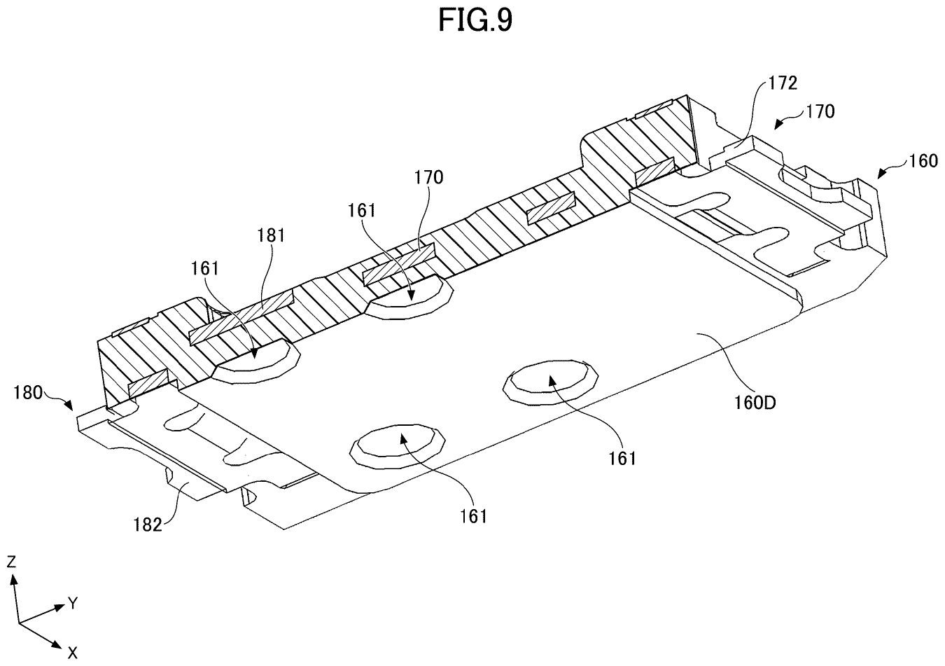

FIG. 8 is a bottom view of the housing 160 provided in the switch 100 according to the embodiment. FIG. 9 is a perspective sectional view of the housing 160 provided in the switch 100 according to the embodiment.

In the switch 100 according to the embodiment, when the housing 160 is insert-molded, the gates of the mold are disposed under the extended supports 176, such that, as illustrated in FIGS. 8 and 9, recessed gate traces 161 are formed on a bottom surface 160D of the housing 160 at positions that overlap with the extended supports 176.

As a result, in the switch 100 according to the embodiment, the gate traces 161 are not formed at the position on the bottom surface 160D of the housing 160 that overlaps with the central fixed contact 171, such that deterioration of the strength at the position that overlap with the central fixed contact 171 (that is, a portion supporting the central fixed contact 171 from the back side of the central fixed contact 171) can be suppressed. Accordingly, deformation of the central fixed contact 171 that may occur when the metal contact 130 contacts the central fixed contact 171 due to pressing of the switch 100 can be suppressed.

In addition, since the gate traces 161 are recessed, even when a burr is generated in the housing 160 when the gate is separated from the housing 160, the burr is generated inside the recess, such that the burr does not project downward from the bottom surface 160D of the housing 160.

In the switch 100 according to the embodiment, back surfaces of the peripheral fixed contacts 181 serve as receivers for receiving resin ejected from the gates when the housing 160 is insert-molded.

In this way, in the switch 100 according to the embodiment, when insert-molding the housing 160, displacement of the peripheral fixed contacts 181 due to the flow of the resin can be suppressed by receiving the resin ejected from the gates by the peripheral fixed contacts 181 without using pins for pressing the peripheral fixed contacts 181 against the mold.

By similarly arranging the gates of the mold under the peripheral fixed contacts 181, as illustrated in FIGS. 8 and 9, the recessed gate traces 161 are also formed on the bottom surface 160D of the housing 160 at the positions overlapping with the peripheral fixed contacts 181.

According to the embodiment, the fixing contacts can be firmly fixed to the housing to be insert-molded.

Although one embodiment of the present invention has been described in detail above, the present invention is not limited to the embodiment, and various modifications or changes can be made within the scope of the gist of the present invention described in the claims.

What is claimed is:

1. A switch, comprising:
a housing having a longitudinal shape;
a first fixed-contact member;
a second fixed-contact member; and
a movable contact member, wherein
the housing includes a casing,
the first fixed-contact member includes:
a first external-connection terminal configured to be exposed from one end in a longitudinal direction of the housing; and
a central fixed contact configured to be exposed from a central portion of a bottom of the casing,
the first fixed-contact member is configured to extend from the first external-connection terminal to the central fixed contact in the longitudinal direction,
the second fixed-contact member includes:
a second external-connection terminal configured to be exposed from another end in the longitudinal direction of the housing; and
a plurality of peripheral fixed contacts configured to be exposed from a peripheral portion of the bottom of the casing,
the second fixed-contact member is configured to extend from the second external-connection terminal to the plurality of peripheral fixed contacts in the longitudinal direction,
the movable contact member is capable of being brought into contact with and detached from the central fixed contact by inversion incurred by pressing,
the first fixed-contact member includes extended supports projecting from sides of the central fixed contact in a transverse direction of the housing, and
back surfaces of the extended supports are configured to serve as receivers for receiving resin ejected from gates upon insert molding of the housing.

2. The switch according to claim 1, wherein
the extended supports are provided as a pair linearly symmetrical with the central fixed contact being interposed between the pair.

3. The switch according to claim 2, wherein
the extended supports are embedded in the housing.

4. The switch according to claim 1, wherein
a chevron-shaped portion of the central fixed contact of the first fixed-contact member, and a valley-shaped portion formed by the plurality of peripheral fixed contacts of the second fixed-contact member, are arranged to face each other.

5. The switch according to claim 1, wherein
on a bottom surface of the housing, a recessed gate trace is formed at positions that overlap with the extended supports, and the gate trace is not formed at a position that overlaps with the central fixed contact.

6. An insert molding method of the housing provided with the switch according to claim 1, the method comprising:
arranging the first fixed-contact member and the second fixed-contact member inside a mold including the gates at positions facing the back surfaces of the extended supports, and
ejecting resin from the gates for filling the mold with resin by ejecting resin toward the back surfaces of the extended supports.
